(19) United States
(12) Patent Application Publication
(10) Pub. No.: US 2025/0286215 A1
(43) Pub. Date: Sep. 11, 2025

(54) SECONDARY BATTERY AND ELECTRONIC DEVICE

(71) Applicant: Dongguan Amperex Technology Limited, Dongguan (CN)

(72) Inventor: Meina YAO, Dongguan (CN)

(73) Assignee: Dongguan Amperex Technology Limited, Dongguan (CN)

(21) Appl. No.: 19/039,005

(22) Filed: Jan. 28, 2025

(30) Foreign Application Priority Data
Mar. 11, 2024 (CN) 202410277253.7

(51) Int. Cl. H01M 50/44; H01M 10/0587; H01M 50/426; H01M 50/434; H01M 50/446; H01M 50/457; H01M 50/491

(52) U.S. Cl. CPC H01M 50/44; H01M 10/0587; H01M 50/426; H01M 50/434; H01M 50/446; H01M 50/457; H01M 50/491

(57) ABSTRACT

An secondary battery includes an electrode assembly. The electrode assembly includes a positive electrode plate, a negative electrode plate, a first separator, and a second separator. The first separator is located between the positive electrode plate and the negative electrode plate. The negative electrode plate is located between the first separator and the second separator. The first separator includes a first base film. The second separator includes a second base film. The first base film is a nonwoven fabric film. The second base film is a microporous film. A thickness of the nonwoven fabric film is 10 μm to 15 μm. A thickness of the microporous film is 5 μm to 9 μm.

### CROSS-REFERENCE TO THE RELATED APPLICATION

This application claims priority to Chinese Patent Application No. 202410277253.7 filed on Mar. 11, 2024, the entire content of which is incorporated herein by reference.

### TECHNICAL FIELD

This application relates to the field of electrochemical technology, and in particular, to a secondary battery and an electronic device.

### BACKGROUND

Compared with other types of batteries such as lead-acid batteries, a lithium-ion battery exhibits the advantages such as a high energy density, a long cycle life, a low self-discharge rate, and environmental protection and no pollution, and has been widely used in the fields such as aviation, aerospace, marine navigation, and electric vehicles. The performance of a separator in a lithium-ion battery decides an interface structure, an internal resistance, and the like of the lithium-ion battery, and directly affects the capacity, cycle performance, and safety performance of the lithium-ion battery. Excellent performance of the separator plays an important role in improving the overall performance of the battery.

Currently, a high-strength thin-film polyolefin porous film (that is, microporous film) is used as a separator of lithium-ion batteries. The microporous film is a high-porosity film with anisotropic pores. The pore size of microporous film is typically 0.1 μm to 1 μm. As a separator of lithium-ion batteries, the microporous film is typically prepared from a material such as polyolefin by uniaxial stretching or biaxial stretching through a wet process or a dry process. However, the glass transition temperature of the polyolefin in the polyolefinic porous film is relatively low. When the internal temperature of the lithium-ion battery rises, the expansion and shrinkage of the separator is prone to impair the safety performance and cycle life of the lithium-ion battery. When nonwoven fabric is used as a separator substrate, the glass transition temperature of the nonwoven fabric is relatively high, thereby alleviating the above problem. However, the thickness of the nonwoven fabric is relatively large, and is prone to cause loss of the energy density of the lithium-ion battery.

### SUMMARY

An objective of this application is to provide a secondary battery and an electronic device to improve the safety performance and prolong the cycle life of the secondary battery while achieving a desirable energy density at the same time.

It is hereby noted that in the description hereof, this application is construed by using a lithium-ion battery as an example of the secondary battery, but the secondary battery of this application is not limited to the lithium-ion battery. Specific technical solutions are as follows:

A first aspect of this application provides a secondary battery. The secondary battery includes an electrode assembly. The electrode assembly includes a positive electrode plate, a negative electrode plate, a first separator, and a second separator. The first separator is located between the positive electrode plate and the negative electrode plate. The negative electrode plate is located between the first separator and the second separator. The first separator includes a first base film. The second separator includes a second base film. The first base film is a nonwoven fabric film. The second base film is a microporous film. A thickness of the nonwoven fabric film is 10 μm to 15 μm. A thickness of the microporous film is 5 μm to 9 μm. When the microporous film is used together with the nonwoven fabric film, during the charge and discharge of the secondary battery, the internal temperature of the secondary battery rises, and the separator can maintain a relatively high porosity, thereby enabling the electrolyte solution to flow smoothly, and improving the transmission rate of lithium ions. By controlling the thickness of the nonwoven fabric film and the thickness of the microporous film within the above ranges, this application endows the nonwoven fabric film and the microporous film with relatively high mechanical strength, thereby improving the safety performance and prolonging the cycle life of the secondary battery while achieving a relatively high energy density of the secondary battery.

In an embodiment of this application, the electrode assembly assumes a jelly-roll structure. The negative electrode plate includes a negative current collector as well as a first negative electrode material layer and a second negative electrode material layer located on two sides of the negative current collector respectively. Along a winding direction of the electrode assembly, a length of the first negative electrode material layer is greater than a length of the second negative electrode material layer. The first separator is located on the same side as the first negative electrode material layer of the negative electrode plate. The second separator is located on the same side as the second negative electrode material layer of the negative electrode plate. When the electrode assembly assumes a jelly-roll structure, the above arrangement makes the porosity of the nonwoven fabric film relatively high, and makes it convenient to adsorb more electrolyte solution. When the first separator is located on the same side as the first negative electrode material layer of the negative electrode plate, it is convenient to store more electrolyte solution on the A side of the negative electrode plate of the secondary battery, thereby reducing the risk of lithium plating at the interface between the electrolyte solution and the negative electrode plate caused by electrolyte flow discontinuity at the later stage of cycling of the secondary battery. In addition, the dual-separator structure containing a microporous film and a nonwoven fabric film disposed in the secondary battery improves the safety performance and prolongs the cycle life of the secondary battery while achieving a desirable energy density. In this application, the A side of the negative electrode plate means one side, containing the first negative electrode material layer, of the negative electrode plate, that is, the side with a relatively long negative electrode material layer in the negative electrode plate.

In an embodiment of this application, the first separator includes a first adhesive layer located on both sides of the first base film and a first ceramic coating disposed on a surface of the first base film on a side close to the positive electrode plate. The first ceramic coating is located between the first base film and the first adhesive layer. The second separator includes a second adhesive layer located on both sides of the second base film and a second ceramic coating disposed on a surface of the second base film on a side facing away from the negative electrode plate. The second ceramic coating is located between the second base film and the second adhesive layer. A coating weight of the first adhesive layer is greater than a coating weight of the second adhesive layer. The first ceramic coating is disposed between the first base film and the first adhesive layer, and the second ceramic coating is disposed between the second base film and the second adhesive layer, thereby improving the heat resistance of the first separator and the second separator and the electrolyte affinity of the first separator and the second separator. The first adhesive layer is disposed on both surfaces of the first base film, and the second adhesive layer is disposed on both surfaces of the second base film, thereby increasing the adhesion between the first separator and the positive electrode plate, the adhesion between the first separator and the negative electrode plate, and the adhesion between the second separator and the negative electrode plate, and in turn, improving the cycle performance of the secondary battery. When the coating weight of the first adhesive layer is greater than the coating weight of the second adhesive layer, the adhesion between the first separator and the positive electrode plate as well the adhesion between the first separator and the negative electrode plate are relatively strong. When the electrode assembly assumes a jelly-roll structure, the extrusion stress at the corner of the electrochemical device is alleviated more favorably. In this way, the secondary battery is endowed with a relatively long cycle life and superior safety performance in addition to a desirable energy density.

In an embodiment of this application, the coating weight of the first adhesive layer is 0.0004 mg/mm² to 0.002 mg/mm², and the coating weight of the second adhesive layer is 0.0004 mg/mm² to 0.002 mg/mm². By controlling the coating weight of the first adhesive layer and the coating weight of the second adhesive layer within the above ranges, this application achieves relatively high adhesion between the first separator and the positive electrode plate, between the first separator and the negative electrode plate, and between the second separator and the negative electrode plate, thereby improving the cycle performance of the secondary battery. With a relatively large coating weight of the first adhesive layer, the adhesion between the first separator and the positive electrode plate as well as the adhesion between the first separator and the negative electrode plate are relatively strong. In this way, the secondary battery is endowed with a relatively long cycle life and superior safety performance in addition to a desirable energy density.

In an embodiment of this application, the coating weight of the first ceramic coating is 7 mg/cm² to 13 mg/cm², and the coating weight of the second ceramic coating is 7 mg/cm² to 13 mg/cm². Controlling the coating weight of the first ceramic coating and the coating weight of the second ceramic coating to fall within the above ranges can improve the thermal stability of the first separator and the second separator, improve the mechanical properties of the first separator and the second separator, and also improve the electrolyte retainability and wettability of the first separator and the second separator. In this way, the secondary battery achieves a relatively long cycle life and superior safety performance in addition to a desirable energy density.

In an embodiment of this application, the first adhesive layer includes a first binder. The second adhesive layer includes a second binder. The first binder and the second binder each are at least one independently selected from polyvinylidene fluoride, polyacrylonitrile, polyethylene oxide, or polyimide. The above types of first binder and second binder can increase the adhesion between the first base film and the first adhesive layer as well as the adhesion between the second base film and the second adhesive layer, thereby improving the cycle performance of the secondary battery. In this way, the secondary battery is endowed with a relatively long cycle life and superior safety performance in addition to a desirable energy density.

In an embodiment of this application, a porosity of the first base film is 40% to 70%, and a porosity of the second base film is 5% to 50%. By controlling the porosity of the first base film and the porosity of the second base film to fall within the above ranges, this application enables lithium ions to exhibit relatively high kinetic performance during charge and discharge of the secondary battery and to adsorb a relatively large amount of electrolyte solution, thereby improving the cycle performance of the secondary battery and prolonging the cycle life of the secondary battery.

In an embodiment of this application, the materials of the first base film include at least one of polyimide, polyamide, polysulfone, polyacrylonitrile, polyester, cellulose, polyetheretherketone, polyphenylene sulfide, polyacrylate ester, polyethylene terephthalate, poly(p-benzamide), polyarylethersulfoneketone, aramid fiber, or poly(aromatic sulfone) fiber; and the materials of the second base film include polyolefin. The polymerization monomers of the polyolefin include at least one of ethylene, propylene, 1-butene, 1-pentene, 1-hexene, 1-octene, 4-methyl-1-pentene, cyclobutene, cyclopentene, or cyclohexene. When the types of materials of the first base film and the second base film fall within the above ranges, the dual-separator structure, that is, the first separator and the second separator, disposed in the secondary battery improves the safety performance of the secondary battery and prolongs the cycle life of the secondary battery while contributing to a desirable energy density.

In an embodiment of this application, a material of the nonwoven fabric film includes polyethylene terephthalate, and a material of the microporous film includes at least one of polypropylene or polyethylene. When the material of the nonwoven fabric film and the material of the microporous film fall within the above ranges, the dual-separator structure containing a microporous film and a nonwoven fabric film disposed in the secondary battery improves the safety performance and prolongs the cycle life of the secondary battery while achieving a desirable energy density.

In an embodiment of this application, a glass transition temperature of the nonwoven fabric film is 80° C. to 100° C., and a glass transition temperature of the microporous film is 25° C. to 50° C. When the glass transition temperature of the nonwoven fabric film and the glass transition temperature of the microporous film fall within the above ranges, a dual-separator structure containing the microporous film and the nonwoven fabric film is disposed in the secondary battery, thereby improving the safety performance of the secondary battery and prolonging the cycle life of the secondary battery while achieving a desirable energy density.

A second aspect of this application provides an electronic device. The electronic device includes the secondary battery disclosed in any one of the preceding embodiments. The secondary battery provided in this application exhibits a relatively long cycle life and superior safety performance in addition to a high energy density. Therefore, the electronic device of this application exhibits a relatively long service life.

Some of the beneficial effects of this application are as follows:

This application provides a secondary battery. The secondary battery includes an electrode assembly. The electrode assembly includes a positive electrode plate, a negative electrode plate, a first separator, and a second separator. The first separator is located between the positive electrode plate and the negative electrode plate. The negative electrode plate is located between the first separator and the second separator. The first separator includes a first base film. The second separator includes a second base film. The first base film is a nonwoven fabric film. The second base film is a microporous film. A thickness of the nonwoven fabric film is 10 μm to 15 μm. A thickness of the microporous film is 5 μm to 9 μm. When the microporous film is used together with the nonwoven fabric film, during the charge and discharge of the secondary battery, the internal temperature of the secondary battery rises, and the separator can maintain a relatively high porosity, thereby enabling the electrolyte solution to flow smoothly, and improving the transmission rate of lithium ions. By controlling the thickness of the nonwoven fabric film and the thickness of the microporous film within the above ranges, this application endows the nonwoven fabric film and the microporous film with relatively high mechanical strength, thereby improving the safety performance and prolonging the cycle life of the secondary battery while achieving a relatively high energy density of the secondary battery.

Definitely, a single product or method in which the technical solution of this application is implemented does not necessarily achieve all of the above advantages concurrently.

### BRIEF DESCRIPTION OF DRAWINGS

To describe the technical solutions in some embodiments of this application or the prior art more clearly, the following outlines the drawings to be used in the description of some embodiments of this application or the prior art. Evidently, the drawings outlined below merely illustrate some embodiments of this application, and a person of ordinary skill in the art may derive other embodiments from the drawings.

FIG. 1 is a schematic structural diagram of an electrode assembly according to an embodiment of this application;

FIG. 2 is a schematic structural diagram of an electrode assembly spread out along a W direction according to another embodiment of this application;

FIG. 3 is a schematic diagram of a jelly-roll structure of the electrode assembly shown in FIG. 2; and

FIG. 4 is a close-up view of a region Q in the electrode assembly shown in FIG. 3.

List of reference numerals: electrode assembly 100; first separator 10; first base film 11; first adhesive layer 12; first ceramic coating 13; second separator 20; second base film 21; second adhesive layer 22; second ceramic coating 23; negative electrode plate 30; negative current collector 31; negative electrode material layer 32; first negative electrode material layer 33; second negative electrode material layer 34; positive electrode plate 40; positive current collector 41; positive electrode material layer 42.

### DETAILED DESCRIPTION

The following describes the technical solutions in some embodiments of this application clearly in detail with reference to the drawings appended hereto. Evidently, the described embodiments are merely a part of but not all of the embodiments of this application. All other embodiments derived by a person skilled in the art based on this application still fall within the protection scope of this application.

It is hereby noted that in specific embodiments of this application, this application is construed by using a lithium-ion battery as an example of the secondary battery, but the secondary battery of this application is not limited to the lithium-ion battery.

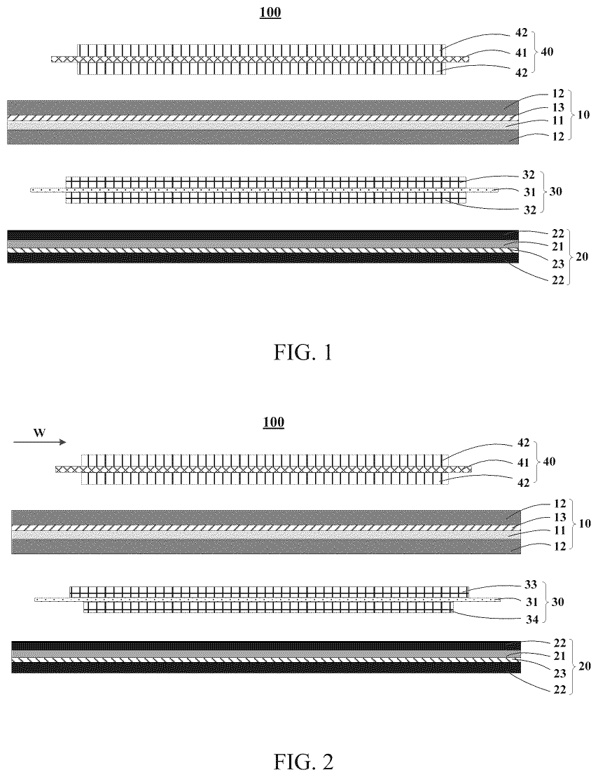

A first aspect of this application provides a secondary battery. As shown in FIG. 1, the secondary battery includes an electrode assembly 100. The electrode assembly 100 includes a first separator 10, a second separator 20, a negative electrode plate 30, and a positive electrode plate 40. The first separator 10 is located between the positive electrode plate 40 and the negative electrode plate 30. The negative electrode plate 30 is located between the first separator 10 and the second separator 20. The first separator 10 includes a first base film 11. The second separator 20 includes a second base film 21. The first base film 11 is a nonwoven fabric film. The second base film 21 is a microporous film. A thickness H1 of the nonwoven fabric film is 10 μm to 15 μm. A thickness H2 of the microporous film is 5 μm to 9 μm. For example, the thickness H1 of the nonwoven fabric film may be 10 μm, 11 μm, 12 μm, 13 μm, 14 μm, 15 μm, or a value falling within a range formed any two thereof; and the thickness H2 of the microporous film may be 5 μm, 6 μm, 7 μm, 8 μm, 9 μm, or a value falling within a range formed any two thereof. The microporous film is typically prepared from a material such as polyolefin by a wet process or a dry process by means of uniaxial stretching or biaxial stretching, or by a thermally induced phase separation method. The microporous film is inexpensive and of relatively high mechanical strength and chemical stability, and is relatively resistant to organic solvents. In addition, the thickness of the microporous film is typically small. When the polymeric microporous film is applied to a secondary battery, assuming that the size of the secondary battery is constant, the volumetric energy density of the secondary battery is relatively high. However, the glass transition temperature of the microporous film is relatively low. During charge and discharge of the secondary battery, when the internal temperature of the secondary battery reaches approximately 60° C., due to the intercalation and deintercalation of lithium ions, the positive electrode plate and the negative electrode plate expand and shrink to generate internal stress. The internal stress is transmitted to the microporous film to squeeze the microporous film, thereby reducing the porosity gradually. The reduced porosity of the microporous film makes it difficult to intercalate and deintercalate lithium ions and shortens the cycle life of the secondary battery. In addition, the reduced porosity of the microporous film makes it difficult to dissipate the heat inside the secondary battery, and results in an excessive temperature rise of the secondary battery, thereby impairing the safety performance of the secondary battery. The nonwoven fabric film is of relatively high capability of storing an electrolyte solution, and the glass transition temperature of the nonwoven fabric film is relatively high, so that the thermal stability of the nonwoven fabric film is relatively high. With the rise of the internal temperature of the secondary battery during charge and discharge, the nonwoven fabric film maintains a relatively high porosity in addition to relatively high mechanical strength, thereby contributing to smooth flow of the electrolyte solution and improving the transmission rate of lithium ions. However, the thickness of the nonwoven fabric film is usually large, and is prone to impair the energy density of the secondary battery. When the thicknesses of the nonwoven fabric film and the microporous film are excessively small, that is, less than the lower limit of the range specified herein, the lithium dendrites generated during cycling of the secondary battery are prone to pierce the microporous film of low strength and cause a short circuit, thereby resulting in a decline in the cycle performance of the secondary battery. When the thickness of the nonwoven fabric film or the microporous film is excessively large, that is, greater than the upper limit of the range specified herein, the transmission path of lithium ions during cycling of the secondary battery is excessively long, thereby deteriorating the kinetic performance of the secondary battery and resulting in a decline in the cycle performance of the secondary battery. When the microporous film is used together with the nonwoven fabric film, by controlling the thickness of the nonwoven fabric film and the thickness of the microporous film within the ranges specified herein, this application endows the nonwoven fabric film and the microporous film with relatively high mechanical strength, thereby improving the safety performance and cycle life of the secondary battery while achieving a desirable energy density. In this application, understandably, the thickness H1 of the nonwoven fabric film is the thickness H1 of the first base film, and the thickness H2 of the microporous film is the thickness H2 of the second base film. The methods for regulating the thickness of the nonwoven fabric film and the thickness of the microporous film are not particularly limited herein, as long as the objectives of this application can be achieved. For example, a nonwoven fabric film and a microporous film of different thicknesses, which are commercially available, may be selected. The thicknesses of the nonwoven fabric film and the microporous film may be determined with reference to the test method of “Determining the thicknesses of the first base film and the second base film” described herein. The nonwoven fabric film and the microporous film of the desired thickness are selected.

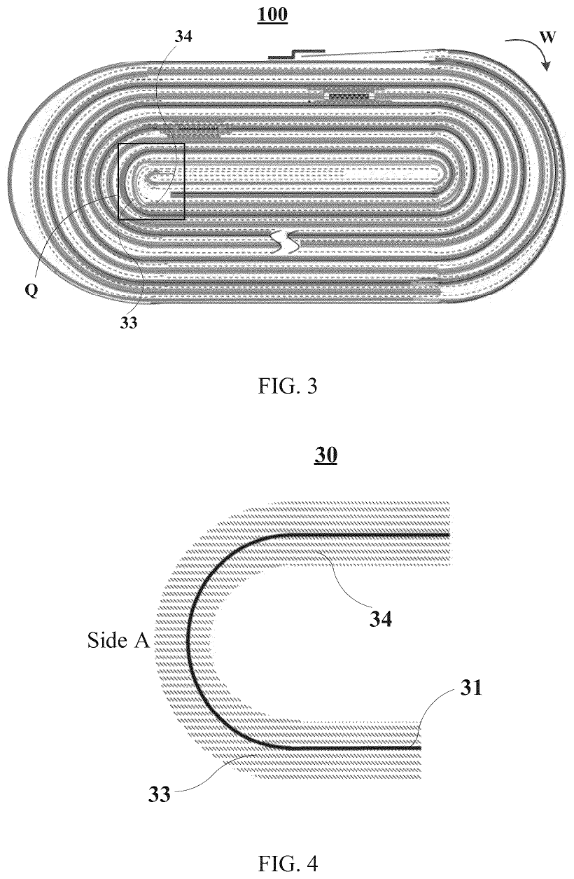

In an embodiment of this application, the electrode assembly assumes a jelly-roll structure. As shown in FIG. 2 and FIG. 3, the negative electrode plate 30 includes a negative current collector 31 as well as a first negative electrode material layer 33 and a second negative electrode material layer 34 located on two sides of the negative current collector 31 respectively. Along a winding direction of the electrode assembly 100, the length of the first negative electrode material layer 33 at both ends is greater than the length of the second negative electrode material layer 34 at both ends. The first separator 10 is located on the same side as the first negative electrode material layer 33 of the negative electrode plate 30. The second separator 20 is located on the same side as the second negative electrode material layer 34 of the negative electrode plate 30. When the electrode assembly assumes a jelly-roll structure, as shown in FIG. 3 and FIG. 4, the above arrangement makes the porosity of the nonwoven fabric film relatively high, and makes it convenient to store more electrolyte solution. When the first separator is located on the same side as the first negative electrode material layer of the negative electrode plate, it is convenient to adsorb more electrolyte solution on the A side of the negative electrode plate of the secondary battery, thereby reducing the risk of lithium plating at the interface between the electrolyte solution and the negative electrode plate caused by electrolyte flow discontinuity at the later stage of cycling of the secondary battery. In addition, the dual-separator structure containing a microporous film and a nonwoven fabric film disposed in the secondary battery improves the safety performance and prolongs the cycle life of the secondary battery while achieving a desirable energy density. In this application, the A side of the negative electrode plate means one side, containing the first negative electrode material layer, of the negative electrode plate, that is, the side with a relatively long negative electrode material layer in the negative electrode plate.

In some embodiments of this application, the electrode assembly assumes a jelly-roll structure. The negative electrode plate includes a negative current collector as well as a first negative electrode material layer and a second negative electrode material layer located on two sides of the negative current collector respectively. Along a winding direction of the electrode assembly, one end of the first negative electrode material layer is flush with one end of the second negative electrode material layer. The length of the first negative electrode material layer at the other end is greater than the length of the second negative electrode material layer at the other end. The first separator is located on the same side as the first negative electrode material layer of the negative electrode plate. The second separator is located on the same side as the second negative electrode material layer of the negative electrode plate. When the electrode assembly assumes a jelly-roll structure, the above arrangement makes the porosity of the nonwoven fabric film relatively high, and makes it convenient to adsorb more electrolyte solution. When the first separator is located on the same side as the first negative electrode material layer of the negative electrode plate, it is convenient to store more electrolyte solution on the A side of the negative electrode plate of the secondary battery, thereby reducing the risk of lithium plating at the interface between the electrolyte solution and the negative electrode plate caused by electrolyte flow discontinuity at the later stage of cycling of the secondary battery. In addition, the dual-separator structure containing a microporous film and a nonwoven fabric film disposed in the secondary battery improves the safety performance and prolongs the cycle life of the secondary battery while achieving a desirable energy density.

In an embodiment of this application, the electrode assembly assumes a jelly-roll structure. As shown in FIG. 1, the negative electrode plate 30 includes a negative current collector 31 and a negative electrode material layer 32 located on both sides of the negative current collector 31. Along a winding direction W of the electrode assembly 100, the length of the negative electrode material layer 32 at one end of the negative current collector 31 is equal to the length of the negative electrode material layer at the other end. When the electrode assembly assumes a jelly-roll structure, the above arrangement improves the safety performance and cycle life of the secondary battery while achieving a desirable energy density.

In an embodiment of this application, as shown in FIG. 1 and FIG. 2, the first separator 10 includes a first adhesive layer 12 located on both sides of the first base film 11 and a first ceramic coating 13 disposed on a surface of the first base film 11 on a side close to the positive electrode plate 40. The first ceramic coating 13 is located between the first base film 11 and the first adhesive layer 12. The second separator 20 includes a second adhesive layer 22 located on both sides of the second base film 21 and a second ceramic coating 23 disposed on a surface of the second base film 21 on a side facing away from the negative electrode plate 30. The second ceramic coating 23 is located between the second base film 21 and the second adhesive layer 22. A coating weight of the first adhesive layer 12 is greater than a coating weight of the second adhesive layer 22. The first ceramic coating is disposed between the first base film and the first adhesive layer, and the second ceramic coating is disposed between the second base film and the first adhesive layer, thereby improving the heat resistance of the first separator and the second separator and the electrolyte affinity of the first separator and the second separator. The first adhesive layer is disposed on both surfaces of the first base film, and the second adhesive layer is disposed on both surfaces of the second base film, thereby increasing the adhesion between the first separator and the positive electrode plate, the adhesion between the first separator and the negative electrode plate, and the adhesion between the second separator and the negative electrode plate, and in turn, improving the cycle performance of the secondary battery, and strengthening the interface between the separator and the positive electrode plate as well as the interface between the separator and the negative electrode plate. This is conducive to the transmission of lithium ions, and also reduces the probability of detachment of the first ceramic coating and the second ceramic coating, thereby improving the cycle performance of the secondary battery. When the coating weight of the first adhesive layer is greater than the coating weight of the second adhesive layer, the adhesion between the first separator and the positive electrode plate as well the adhesion between the first separator and the negative electrode plate are relatively strong. When the electrode assembly assumes a jelly-roll structure, the extrusion stress at the corner of the electrochemical device is alleviated more favorably, thereby reducing the risk of electrolyte flow discontinuity at the corner of the electrochemical device. In this way, the secondary battery is endowed with a relatively long cycle life and superior safety performance in addition to a desirable energy density.

In an embodiment of this application, the coating weight CW1 of the first adhesive layer is 0.0004 mg/mm² to 0.002 mg/mm², and the coating weight CW2 of the second adhesive layer is 0.0004 mg/mm² to 0.002 mg/mm². For example, the coating weight CW1 of the first adhesive layer may be 0.0004 mg/mm², 0.0008 mg/mm², 0.001 mg/mm², 0.0012 mg/mm², 0.0015 mg/mm², 0.0018 mg/mm², 0.002 mg/mm², or a value falling within a range formed by any two thereof; and the coating weight CW2 of the second adhesive layer may be 0.0004 mg/mm², 0.0008 mg/mm², 0.001 mg/mm², 0.0012 mg/mm², 0.0015 mg/mm², 0.0018 mg/mm², 0.002 mg/mm², or a value falling within a range formed by any two thereof. By controlling the coating weight of the first adhesive layer and the coating weight of the second adhesive layer within the above ranges, this application achieves relatively high adhesion between the first separator and the positive electrode plate, between the first separator and the negative electrode plate, and between the second separator and the negative electrode plate, and strengthens the interface between the first separator and the positive electrode plate, the interface between the first separator and the negative electrode plate, and the interface between the second separator and the negative electrode plate. This is conducive to the transmission of lithium ions, and also reduces the probability of detachment of the first ceramic coating and the second ceramic coating, thereby improving the cycle performance of the secondary battery. With a relatively large coating weight of the first adhesive layer, the adhesion between the first separator and the positive electrode plate as well the adhesion between the first separator and the negative electrode plate are relatively strong. When the electrode assembly assumes a jelly-roll structure, the extrusion stress at the corner of the electrochemical device is alleviated more favorably, thereby reducing the risk of electrolyte flow discontinuity at the corner of the electrochemical device. In this way, the secondary battery is endowed with a relatively long cycle life and superior safety performance in addition to a desirable energy density. In this application, the coating weight of the first adhesive layer and the coating weight of the second adhesive layer may be adjusted by a method known to a person skilled in the art. For example, when the first adhesive layer slurry is applied onto the surface of the first base film, with the solid content of the first adhesive layer slurry being constant, the coating amount of the first adhesive layer slurry is increased to increase the coating weight of the first adhesive layer; when the second adhesive layer slurry is applied onto the surface of the second base film, with the solid content of the second adhesive layer slurry being constant, the coating amount of the second adhesive layer slurry is increased to increase the coating weight of the second adhesive layer. The adjustment method is not particularly limited herein, as long as the objectives of this application can be achieved.

In an embodiment of this application, the coating weight CW3 of the first ceramic coating is 7 mg/cm² to 13 mg/cm², and the coating weight CW4 of the second ceramic coating is 7 mg/cm² to 13 mg/cm². For example, the coating weight CW3 of the first ceramic coating may be 7 mg/cm², 8 mg/cm², 9 mg/cm², 10 mg/cm², 11 mg/cm², 12 mg/cm², 13 mg/cm², or a value falling within a range formed by any two thereof; and the coating weight CW4 of the second ceramic coating may be 7 mg/cm², 8 mg/cm², 9 mg/cm², 10 mg/cm², 11 mg/cm², 12 mg/cm², 13 mg/cm², or a value falling within a range formed by any two thereof. Controlling the coating weight of the first ceramic coating and the coating weight of the second ceramic coating to fall within the above ranges can improve the thermal stability and strength of the first separator and the second separator, improve the mechanical properties of the separators, reduce the probability of large-area contact between the positive electrode plate and the negative electrode plate caused by the shrinkage of the first separator and/or the second separator during charge and discharge of the secondary battery, and improve the capability of binding the first separator and the second separator, thereby improving the safety performance of the secondary battery. At the same time, the first ceramic coating and the second ceramic coating can absorb a part of the electrolyte solution, and therefore, controlling the coating weight of the first ceramic coating and the coating weight of the second ceramic coating to fall within the above ranges can increase the electrolyte retention amount of the first separator and the second separator, and improve the electrolyte retainability and wettability of the first separator and the second separator. In this way, the secondary battery achieves a relatively long cycle life and superior safety performance in addition to a desirable energy density. In this application, the coating weight of the first ceramic coating and the coating weight of the second ceramic coating may be adjusted by a method known to a person skilled in the art. For example, when the first ceramic coating slurry is applied onto the surface of the first base film, with the solid content of the first ceramic coating slurry being constant, the coating amount of the first ceramic coating slurry is increased to increase the coating weight of the first ceramic coating; when the second ceramic coating slurry is applied onto the surface of the second base film, with the solid content of the second ceramic coating slurry being constant, the coating amount of the second ceramic coating slurry is increased to increase the coating weight of the second ceramic coating. The adjustment method is not particularly limited herein, as long as the objectives of this application can be achieved.

In an embodiment of this application, the first adhesive layer includes a first binder. The second adhesive layer includes a second binder. The first binder and the second binder each are at least one independently selected from polyvinylidene fluoride, polyacrylonitrile, polyethylene oxide, or polyimide. The above types of first binder and second binder can improve the adhesion between the first base film and the first adhesive layer, and the adhesion between the second base film and the second adhesive layer, thereby improving the adhesion between the first separator and the positive electrode plate, between the first separator and the negative electrode plate, and between the second separator and the negative electrode plate, and strengthening the interface between the first separator and the positive electrode plate, the interface between the first separator and the negative electrode plate, and the interface between the second separator and the negative electrode plate. This is conducive to the transmission of lithium ions, and also reduces the probability of detachment of the first ceramic coating and the second ceramic coating, thereby improving the cycle performance of the secondary battery. In this way, the secondary battery is endowed with a relatively long cycle life and superior safety performance in addition to a desirable energy density. The weight-average molecular weight of the first binder and the weight-average molecular weight of the second binder are not particularly limited herein, as long as the objectives of this application can be achieved. For example, the weight-average molecular weight of the first binder and the second binder may be 1.5×10⁴ to 9×10⁶.

In an embodiment of this application, a porosity P1 of the first base film is 40% to 70%, and a porosity P2 of the second base film is 5% to 50%. For example, the porosity P1 of the first base film may be 40%, 43%, 45%, 47%, 50%, 53%, 55%, 57%, 60%, 63%, 65%, 67%, 70%, or a value falling within a range formed by any two thereof; and the porosity P2 of the second base film may be 5%, 7%, 10%, 13%, 15%, 17%, 20%, 23%, 25%, 27%, 30%, 33%, 35%, 37%, 40%, 43%, 45%, 47%, 50%, or a value falling within a range formed by any two thereof. Controlling the porosity of the first base film and the porosity of the second base film within the above ranges contributes to relatively high strength of the first separator and the second separator, and improves the safety performance of the secondary battery. This contributes to relatively high kinetic performance of lithium ions during charge and discharge of the secondary battery, and also enables the lithium ions to adsorb a relatively large amount of electrolyte solution, and contributes to relatively high wettability of the first separator and the second separator, thereby facilitating transmission of the lithium ions, and in turn, improving the cycle performance and cycle life of the secondary battery. The methods for regulating the porosity of the first base film and the porosity of the second base film are not particularly limited herein, as long as the objectives of this application can be achieved. For example, a nonwoven fabric film and a microporous film of different porosities, which are commercially available, may be selected. The porosity of the first base film and the porosity of the second base film may be determined with reference to the test method of “Determining the porosities of the first base film and the second base film” described herein. The nonwoven fabric film and the microporous film of the desired porosity are selected.

In an embodiment of this application, the materials of the first base film include at least one of polyimide, polyamide, polysulfone, polyacrylonitrile, polyester, cellulose, polyetheretherketone, polyphenylene sulfide, polyacrylate ester, polyethylene terephthalate (PET), poly(p-benzamide), polyarylethersulfoneketone, aramid fiber, or poly(aromatic sulfone) fiber; and the materials of the second base film include polyolefin. The polymerization monomers of the polyolefin include at least one of ethylene, propylene, 1-butene, 1-pentene, 1-hexene, 1-octene, 4-methyl-1-pentene, cyclobutene, cyclopentene, or cyclohexene. For example, the material of the second base film may include at least one of polyethylene, polypropylene, poly-1-butene, poly-1-pentene, poly-1-hexene, poly-1-octene, poly-4-methyl-1-pentene, polycyclobutene, polycyclopentene, polycyclohexene, or poly(ethylene-co-propylene). When the types of materials of the first base film and the second base film fall within the above ranges, the dual-separator structure, that is, the first separator and the second separator, disposed in the secondary battery improves the safety performance of the secondary battery and prolongs the cycle life of the secondary battery while contributing to a desirable energy density. The weight-average molecular weight of the material of the first base film is not particularly limited herein, as long as the objectives of this application can be achieved. For example, the weight-average molecular weight of the material of the first base film is 2×10⁵ to 1.5×10⁶. The weight-average molecular weight of the material of the second base film is not particularly limited herein, as long as the objectives of this application can be achieved. For example, the weight-average molecular weight of the material of the second base film is 2×10⁵ to 1.5×10⁶.

In an embodiment of this application, a material of the nonwoven fabric film includes polyethylene terephthalate, and a material of the microporous film includes at least one of polypropylene (PP) or polyethylene (PE). When the material of the nonwoven fabric film and the material of the microporous film fall within the above ranges, the dual-separator structure containing a microporous film and a nonwoven fabric film disposed in the secondary battery improves the safety performance and prolongs the cycle life of the secondary battery while achieving a desirable energy density. The method for preparing the microporous film is not particularly limited herein, as long as the objectives of this application can be achieved. For example, the microporous film is prepared from a material falling within the range specified herein by a wet process or a dry process by means of uniaxial stretching or biaxial stretching, or by a thermally induced phase separation method. The method for preparing the nonwoven fabric film is not particularly limited herein, as long as the objectives of this application can be achieved. For example, the nonwoven fabric film may be prepared from a material falling within the range specified herein by at least one of the following methods: meltblowing, spunbonding, wet papermaking, hydroentangling, needlepunching, or hot rolling. In this application, understandably, the material of the nonwoven fabric film is the material of the first base film, and the material of the microporous film is the material of the second base film. Alternatively, a nonwoven fabric film and a microporous film of different materials, which are commercially available, are selected, and the first base film and the second base film of desired materials are selected. The materials are not particularly limited herein, as long as the objectives of this application can be achieved.

In an embodiment of this application, a glass transition temperature Tg1 of the nonwoven fabric film is 80° C. to 100° C., and a glass transition temperature Tg2 of the microporous film is 25° C. to 50° C. For example, the glass transition temperature Tg1 of the nonwoven fabric film may be 80° C., 83° C., 85° C., 87° C., 90° C., 92° C., 95° C., 97° C., 100° C., or a value falling within a range formed by any two thereof; and the glass transition temperature Tg2 of the microporous film may be 25° C., 27° C., 30° C., 32° C., 35° C., 37° C., 40° C., 42° C., 45° C., 47° C., 50° C., or a value falling within a range formed by any two thereof. When the glass transition temperature of the nonwoven fabric film and the glass transition temperature of the microporous film fall within the above ranges, a dual-separator structure containing the microporous film and the nonwoven fabric film is disposed in the secondary battery, thereby improving the safety performance of the secondary battery and prolonging the cycle life of the secondary battery while achieving a desirable energy density. The methods for regulating the glass transition temperature of the nonwoven fabric film and the glass transition temperature of the microporous film are not particularly limited herein, as long as the objectives of this application can be achieved. For example, the glass transition temperature may be regulated by selecting different types of nonwoven fabric films and microporous films. In this application, understandably, the glass transition temperature Tg1 of the nonwoven fabric film is the glass transition temperature Tg1 of the first base film, and the glass transition temperature Tg2 of the microporous film is the glass transition temperature Tg2 of the second base film.

In an embodiment of this application, the first ceramic coating includes first ceramic particles, and the second ceramic coating includes second ceramic particles. The first ceramic particles and the second ceramic particles each are at least one independently selected from aluminum oxide, boehmite, titanium dioxide, silicon dioxide, zirconium dioxide, tin dioxide, magnesium hydroxide, magnesium oxide, zinc oxide, barium sulfate, boron nitride, aluminum nitride, or silicon nitride. With the above types of ceramic particles selected, the first ceramic coating and the second ceramic coating can achieve relatively high hardness and a superior heat resistance.

In an embodiment of this application, the first ceramic coating includes first ceramic particles and a first ceramic coating binder, and the second ceramic coating includes second ceramic particles and a second ceramic coating binder. The types of the first ceramic coating binder and the second ceramic coating binder are not particularly limited herein, as long as the objectives of this application can be achieved. For example, the first ceramic coating binder and the second ceramic coating binder each are at least one independently selected from styrene-butadiene rubber, polyvinyl alcohol, polyvinylidene fluoride, polyacrylic acid, polymethyl methacrylate, polybutyl acrylate, or polyacrylonitrile. The content of the first ceramic particles and the content of the first ceramic coating binder in the first ceramic coating, and the content of the second ceramic particles and the content of the second ceramic coating binder in the second ceramic coating, are not particularly limited herein, as long as the objectives of this application can be achieved. For example, based on the mass of the first ceramic coating, the mass percent of the first ceramic particles is 5% to 95%, and the mass percent of the first ceramic coating binder is 5% to 95%; and, based on the mass of the second ceramic coating, the mass percent of the second ceramic particles is 5% to 95%, and the mass percent of the second ceramic coating binder is 5% to 95%.

In an embodiment of this application, the first adhesive layer may include a first thickener, and the second adhesive layer may further include a second thickener. Based on the mass of the first adhesive layer, the mass percent of the first thickener is 0.3% to 6%. Based on the mass of the second adhesive layer, the mass percent of the second thickener is 0.3% to 6%. Applying the first thickener to the first adhesive layer and applying the second thickener to the second adhesive layer can increase the stability of the first adhesive layer slurry and the second adhesive layer slurry, and prevent the sedimentation of each constituent in the first adhesive layer slurry and the second adhesive layer slurry. The types of the first thickener and the second thickener are not particularly limited herein, as long as the objectives of this application can be achieved. For example, the first thickener and the second thickener each independently are at least one selected from hydroxyethyl cellulose, methyl hydroxyethyl cellulose, sodium carboxymethyl cellulose, polyacrylamide, or sodium alginate.

The method for preparing the first separator is not particularly limited herein, as long as the objectives of this application can be achieved. For example, the preparation method of the first separator includes, but is not limited to, the following steps: (1) mixing the first binder with the first thickener well to obtain a first adhesive layer slurry; (2) mixing first ceramic particles with a first ceramic coating binder well to obtain a first ceramic coating slurry; (3) applying the first adhesive layer slurry onto one surface of the first base film, and performing oven-drying to form a first adhesive layer on one surface of the first base film; applying the first ceramic coating slurry onto the other surface of the first base film, and performing oven-drying to form a first ceramic coating on the other surface of the first base film; applying the first adhesive layer slurry onto a surface of the first ceramic coating on a side away from the first base film, and performing oven-drying to form a first adhesive layer on the surface of the first ceramic coating on the side away from the first base film, thereby obtaining the first separator.

The method for preparing the second separator is not particularly limited herein, as long as the objectives of this application can be achieved. For example, the preparation method of the second separator includes, but is not limited to, the following steps: (1) mixing a second binder with a second thickener well to obtain a second adhesive layer slurry; (2) mixing second ceramic particles with a second ceramic coating binder well to obtain a second ceramic coating slurry; (3) applying the second adhesive layer slurry onto one surface of the second base film, and performing oven-drying to form a second adhesive layer on one surface of the second base film; applying the second ceramic coating slurry onto the other surface of the second base film, and performing oven-drying to form a second ceramic coating on the other surface of the second base film; applying the second adhesive layer slurry onto a surface of the second ceramic coating on a side away from the second base film, and performing oven-drying to form a second adhesive layer on the surface of the second ceramic coating on the side away from the second base film, thereby obtaining the second separator.

The negative current collector is not particularly limited herein, as long as the objectives of this application can be achieved. For example, the negative current collector may be copper foil, copper alloy foil, nickel foil, stainless steel foil, titanium foil, foamed nickel, foamed copper, a composite current collector (such as a lithium-copper composite current collector, a carbon-copper composite current collector, a nickel-copper composite current collector, or a titanium-copper composite current collector), or the like. The negative electrode material layer or the first negative electrode material layer and the second negative electrode material layer of this application each contain a negative active material. The type of the negative active material is not particularly limited in this application, as long as the objectives of this application can be achieved. For example, the negative active material may include at least one of natural graphite, artificial graphite, mesocarbon microbeads (MCMB), hard carbon, soft carbon, silicon, a silicon-carbon composite, SiOₓ (0<x<2), Li—Sn alloy, Li—Sn—O alloy, Sn, SnO, SnO₂, spinel-structured lithium titanium oxide Li₄Ti₅O₁₂, Li—Al alloy, or metallic lithium. The thicknesses of the negative current collector and the negative electrode material layer are not particularly limited herein, as long as the objectives of this application can be achieved. For example, the thickness of the negative current collector is 4 μm to 15 μm, the thickness of the negative electrode material layer on a single side of the current collector is 30 μm to 130 μm, the thickness of the first negative electrode material layer is 30 μm to 130 μm, and the thickness of the second negative electrode material layer is 30 μm to 130 μm. Optionally, the negative electrode material layer, the first negative electrode material layer, and the second negative electrode material layer each may further include a conductive agent and a negative electrode binder. The types of the conductive agents in the negative electrode material layer, the first negative electrode material layer, and the second negative electrode material layer are not particularly limited herein, as long as the objectives of this application can be achieved. For example, the conductive agent may include, but is not limited to, at least one of conductive carbon black (Super P), carbon nanotubes (CNTs), carbon fibers, flake graphite, Ketjen black, graphene, a metal material, or a conductive polymer. The carbon nanotubes may include, but are not limited to, single-walled carbon nanotubes and/or multi-walled carbon nanotubes. The carbon fibers may include, but are not limited to, vapor grown carbon fibers (VGCF) and/or carbon nanofibers. The metal material may include, but is not limited to, metal powder and/or metal fibers. Specifically, the metal may include, but is not limited to, at least one of copper, nickel, aluminum, or silver. The conductive polymer may include, but is not limited to, at least one of polyphenylene derivatives, polyaniline, polythiophene, polyacetylene, or polypyrrole. The types of the negative electrode binders in the negative electrode material layer, the first negative electrode material layer, and the second negative electrode material layer are not particularly limited herein, as long as the objectives of this application can be achieved. For example, the negative electrode binder may include, but is not limited to, at least one of polyvinylidene fluoride, poly(vinylidene fluoride-co-hexafluoropropylene), polyamide, polyacrylonitrile, polyacrylate, polyacrylic acid, polyacrylic acid sodium salt, polyvinylpyrrolidone, polyvinyl ether, polymethyl methacrylate, polytetrafluoroethylene, or polyhexafluoropropylene. The mass ratio between the negative active material, conductive agent, and negative electrode binder in the negative electrode material layer, the first negative electrode material layer, and the second negative electrode material layer is not particularly limited herein, as long as the objectives of this application can be achieved.

In this application, the positive electrode plate is not particularly limited, as long as the objectives of this application can be achieved. In an embodiment of this application, when the electrode assembly assumes a jelly-roll structure, the positive electrode plate includes a positive current collector and a positive electrode material layer disposed on at least one surface of the positive current collector. “Positive electrode material layer disposed on at least one surface of the positive current collector” means that the positive electrode material layer may be disposed on one surface of the positive current collector or on both surfaces of the positive electrode current collector along the thickness direction of the current collector. It is hereby noted that the “surface” here may be the entire region of the surface of the positive current collector, or a partial region of the surface of the positive current collector, without being particularly limited herein, as long as the objectives of the application can be achieved. As an example, as shown in FIG. 1 and FIG. 2, a positive electrode plate 40 includes a positive current collector 41 and a positive electrode material layer 42 disposed on both surfaces of the positive current collector 41. The positive current collector is not particularly limited herein, as long as the objectives of this application can be achieved. For example, the positive current collector may include aluminum foil, aluminum alloy foil, a composite current collector (such as an aluminum carbon composite current collector), or the like. The positive electrode material layer of this application includes a positive active material. The type of the positive active material is not particularly limited herein, as long as the objectives of this application can be achieved. For example, the positive active material may include at least one of lithium nickel cobalt manganese oxide (NCM811, NCM622, NCM523, NCM111), lithium nickel cobalt aluminum oxide, lithium iron phosphate, a lithium-rich manganese-based material, lithium cobalt oxide (LiCoO₂), lithium manganese oxide, lithium manganese iron phosphate, lithium titanium oxide, or the like. In this application, the positive active material may further include a non-metal element. For example, the non-metal element includes at least one of fluorine, phosphorus, boron, chlorine, silicon, or sulfur. The thicknesses of the positive current collector and the positive electrode material layer are not particularly limited herein, as long as the objectives of this application can be achieved. For example, the thickness of the positive current collector is 9 μm to 15 μm. The thickness of the positive electrode material layer on a single side is 30 μm to 120 μm. In this application, the positive electrode material layer may further include a conductive agent and a positive electrode binder. The type of the binder in the positive electrode material layer is not particularly limited herein, as long as the objectives of this application can be achieved. For example, the positive electrode binder may be of the same type as the negative electrode binders in the negative electrode material layer, the first negative electrode material layer, and the second negative electrode material layer. The type of the conductive agent in the positive electrode material layer is not particularly limited herein, as long as the objectives of this application can be achieved. The conductive agent may be of the same type as the conductive agents in the negative electrode material layer, the first negative electrode material layer, and the second negative electrode material layer. The mass ratio between the positive active material, the conductive agent, and the positive electrode binder in the positive electrode material layer is not particularly limited herein, and may be selected by a person skilled in the art as actually required, as long as the objectives of this application can be achieved.

The secondary battery in this application includes an electrolyte solution. The electrolyte solution includes a lithium salt and a nonaqueous solvent. The lithium salt may include at least one of LiPF₆, LiNO₃, LiBF₄, LiClO₄, LiB(C₆H₅)₄, LICH₃SO₃, LiCF₃SO₃, LiN(SO₂CF₃)₂, LiC(SO₂CF₃)₃, Li₂SiF₆, lithium bis(oxalato) borate (LiBOB), lithium bis(trifluoromethanesulfonyl)imide (LiTFSI), or lithium difluoroborate. The content of the lithium salt in the electrolyte solution is not particularly limited herein, as long as the objectives of this application can be achieved. The nonaqueous solvent is not particularly limited herein, as long as the objectives of this application can be achieved. For example, the nonaqueous solvent includes, but is not limited to, at least one of a carbonate ester compound, a carboxylate ester compound, an ether compound, or another organic solvent. The carbonate compound may include, but is not limited to, at least one of a chain carbonate compound, a cyclic carbonate compound, or a fluorocarbonate compound. The chain carbonate compound may include, but is not limited to, at least one of dimethyl carbonate, diethyl carbonate, dipropyl carbonate, methyl propyl carbonate, ethylene propyl carbonate, or ethyl methyl carbonate. The cyclic carbonate compound may include, but is not limited to, at least one of ethylene carbonate, propylene carbonate (PC), butylene carbonate, or vinyl ethylene carbonate. The fluorocarbonate compound may include, but is not limited to, at least one of fluoroethylene carbonate, 1,2-difluoroethylene carbonate, 1,1-difluoroethylene carbonate, 1,1,2-trifluoroethylene carbonate, 1,1,2,2-tetrafluoroethylene carbonate, 1-fluoro-2-methyl ethylene, 1-fluoro-1-methyl ethylene carbonate, 1,2-difluoro-1-methyl ethylene carbonate, 1,1,2-trifluoro-2-methyl ethylene carbonate, or trifluoromethyl ethylene carbonate. The carboxylate compound may include, but is not limited to, at least one of methyl formate, methyl acetate, ethyl acetate, n-propyl acetate, tert-butyl acetate, methyl propionate, ethyl propionate, propyl propionate, γ-butyrolactone, decanolactone, valerolactone, or caprolactone. The ether compound may include, but is not limited to, at least one of dibutyl ether, tetraglyme, diglyme, 1,2-dimethoxyethane, 1,2-diethoxyethane, 1-ethoxy-1-methoxyethane, 2-methyltetrahydrofuran, or tetrahydrofuran. The other organic solvent may include, but is not limited to, at least one of dimethyl sulfoxide, 1,2-dioxolane, sulfolane, methyl sulfolane, 1,3-dimethyl-2-imidazolidinone, N-methyl-2-pyrrolidone, dimethylformamide, acetonitrile, trimethyl phosphate, triethyl phosphate, or trioctyl phosphate.

The secondary battery of this application further includes a packaging bag. The packaging bag is configured to accommodate a positive electrode plate, a negative electrode plate, a separator, an electrolyte solution, and other components known in the art for use in a secondary battery. Such other components are not limited herein. The packaging bag is not particularly limited herein, and may be a packaging bag well-known in the art, as long as the objectives of this application can be achieved.

The secondary battery is not particularly limited in this application, and may be any device in which an electrochemical reaction occurs. In an embodiment of this application, the secondary battery may be, but is not limited to, a lithium-ion secondary battery (lithium-ion battery), a lithium polymer secondary battery, a lithium-ion polymer secondary battery, or the like.

The method for preparing the secondary battery is not particularly limited herein, and may be any preparation method well-known in the art, as long as the objectives of this application can be achieved. For example, the method for preparing the secondary battery includes, but is not limited to, the following steps: stacking the positive electrode plate, the first separator, the negative electrode plate, and the second separator in sequence, and performing operations such as winding and folding as required on the stacked structure to obtain a jelly-roll electrode assembly; putting the electrode assembly into a packaging bag, injecting an electrolyte solution into the packaging bag, and sealing the package bag to obtain a secondary battery.

A second aspect of this application provides an electronic device. The electronic device includes the secondary battery disclosed in any one of the preceding embodiments. The secondary battery provided in this application exhibits a relatively long cycle life and superior safety performance in addition to a high energy density. Therefore, the electronic device of this application exhibits a relatively long service life.

The electronic device is not particularly limited herein, and may be any electronic device known in the prior art. For example, the electronic device may include, but is not limited to, a laptop computer, pen-inputting computer, mobile computer, e-book player, portable phone, portable fax machine, portable photocopier, portable printer, stereo headset, video recorder, liquid crystal display television set, handheld cleaner, portable CD player, mini CD-ROM, transceiver, electronic notepad, calculator, memory card, portable voice recorder, radio, backup power supply, motor, automobile, motorcycle, power-assisted bicycle, bicycle, lighting appliance, toy, game console, watch, electric tool, flashlight, camera, large household storage battery, or lithium-ion capacitor.

### EMBODIMENTS

The implementations of this application are described below in more detail with reference to embodiments and comparative embodiments. Various tests and evaluations are performed by the following methods.

### Test Methods and Devices

### Method for Obtaining Samples of the First Base Film and the Second Base Film

Disassembling a lithium-ion battery in each embodiment and comparative embodiment to be tested, taking out a first separator and a second separator, and soaking the separators in dimethyl carbonate (DMC) for 20 minutes to remove residual electrolyte solution. Subsequently, drying the first separator and the second separator in an oven at 60° C. for 12 hours to obtain a first separator sample and a second separator sample. Placing the first separator sample and second separator sample, which are cleaned through DMC and oven-dried, into a container, adding an appropriate amount of N-methylpyrrolidone (NMP), and putting the container into an ultrasonic instrument with a heating function for ultrasonication. Setting the temperature to 45° C., and keeping the ultrasonication for 3 hours. Taking out the container when the first separator and the second separator become completely transparent, so as to obtain a first base film sample and a second base film sample. The first base film and the second base film are sampled by the above method in the following tests to determine the porosities of the first base film and the second base film, the thicknesses of the first base film and the second base film, and the glass transition temperatures of the first base film and the second base film.

### Determining the Porosities of the First Base Film and the Second Base Film

The porosities of the first base film and the second base film are determined by a gas displacement method. The first base film sample and the second base film sample are die-cut with a die to prepare specimens (a person skilled in the art may select a die of a typical size and a typical shape in the art based on factors such as the size and shape of the samples and the requirements of the test instrument). A true volume V0 of the specimen is measured by using a true density tester. The apparent volume V of the specimen may be calculated based on the area and thickness of the specimen. Therefore, the percentage of the pore volume of the sample in relation to the total area, that is, the porosity of the first base film or the second base film, is calculated as: P=(V−V0)/V×100%.

### Determining the Thicknesses of the First Base Film and the Second Base Film

Obtaining a cross-sectional scanning electron microscope (SEM) test specimen of the first base film by performing steps such as washing, oven-drying, cutting, and polishing on a first base film sample. Observing the morphology of the cross-section of the first base film along the thickness direction by using a field emission scanning electron microscope (XL-30, from Philips), and capturing an SEM image. Measuring the thickness of the first base film by using the scanning electron microscope, that is, the thickness H1 of the nonwoven fabric film.

Obtaining a cross-sectional scanning electron microscope (SEM) test specimen of the second base film by performing steps such as washing, oven-drying, cutting, and polishing on a second base film sample. Observing the morphology of the cross-section of the second base film along the thickness direction by using a field emission scanning electron microscope (XL-30, from Philips), and capturing an SEM image. Measuring the thickness of the second base film by using the scanning electron microscope, that is, the thickness H2 of the microporous film.

### Determining the Glass Transition Temperatures of the First Base Film and the Second Base Film

Testing the glass transition temperature of a nonwoven fabric film (the first base film sample) and a microporous film (the second base film sample) by using a differential scanning calorimeter (DSC). Die-cutting the first base film sample and the second base film sample by using a die, so as to prepare specimen (a person skilled in the art may select the die of a typical size and shape in the art based on factors such as the dimensions and shape of the specimen and the requirements of the test instrument). Hermetically packaging the prepared specimen in a ziplock bag to avoid contamination. During the test, taking out the specimen and placing the specimen into a crucible. Putting the crucible into a furnace. Increasing the temperature from −100° C. to 800° C. at a heating rate of 5° C./min. Controlling the temperature change by using a program. Determining the relationship between a power difference (a difference in power between the specimen and a reference, that is, heat flow rate) and the measured temperature of the specimen during change of the temperature, so as to obtain the melting point, crystallinity, crystallization temperature, and other information of the specimen. Obtaining, through a DSC curve, the glass transition temperature of the specimen, that is, the glass transition temperature Tg1 of the nonwoven fabric film and the glass transition temperature Tg2 of the microporous film.

### Determining the Thickness of the Lithium-Ion Battery

Adjusting, by adding or removing a weight, the test pressure to a 600 g pressure required by the voltage, placing a 3 mm gauge block onto a loading platform, pressing the white buttons on both sides of the instrument so that the parallel plate gauge (PPG battery thickness gauge) automatically feeds the gauge block into the instrument and tests the thickness. Measuring any 9 points in sequence, with a calibration tolerance of +0.02 mm. Using only the item that falls within the specification range. Holding the lithium-ion battery with one hand, placing the battery on the loading platform with the barcode facing up. Scanning the barcode first, and then pressing the white buttons on both sides so that the instrument automatically feeds the lithium-ion battery for testing. Recording the test result, that is, the thickness of the lithium-ion battery.

The thickness of the lithium-ion battery characterizes the energy density of the lithium-ion battery. For lithium-ion batteries of the same volume, a larger thickness represents a lower energy density.

### Testing the Cycle Performance

Charging a lithium-ion battery at a constant current of 2 C at 25° C. until the voltage reaches 4.5 V, and then charging the battery at a constant voltage of 4.5 V until the current tapers off to 0.02 C. Leaving the battery to stand for 5 minutes, and then discharging the battery at a constant current of 0.7 C until the voltage drops to 3.0 V, thereby completing a first cycle. Recording the discharge capacity at this time. Charging and discharging the lithium-ion battery according to the above process until completion of 1000 cycles (cls). Calculating the capacity retention rate as a metric of the cycle performance of the lithium-ion battery.

Capacity retention rate (%)=(1000^{th}-cycle discharge capacity/first-cycle discharge capacity)×100%.

### Hot-Oven Test

Charging a lithium-ion battery at 25° C. at a constant current of 2 C until the voltage reaches 4.5 V, and then charging the battery at a constant voltage of 4.5 V until the current tapers off to 0.02 C. Subsequently, leaving the lithium-ion battery to stand for 5 minutes in a test chamber ventilated with air at a temperature of 25° C. and a humidity of 80%, and then heating the test chamber to 130° C. at a rate of 5° C./min. Keeping the temperature constant at 130° C. for 10 minutes, and then checking whether the lithium-ion battery catches fire or explodes. Determining that the battery passes the test if the battery does not catch fire or explode. Calculating the 130° C. hot-oven test pass rate as: hot-oven test pass rate=number of batteries passing the 130° C. hot-oven test/5 (total number of batteries tested in 130° C. hot oven).

Charging a lithium-ion battery at 25° C. at a constant current of 2 C until the voltage reaches 4.5 V, and then charging the battery at a constant voltage of 4.5 V until the current tapers off to 0.02 C. Subsequently, leaving the lithium-ion battery to stand for 5 minutes in a test chamber ventilated with air at a temperature of 25° C. and a humidity of 80%, and then heating the test chamber to 135° C. at a rate of 5° C./min. Keeping the temperature constant at 135° C. for 10 minutes, and then checking whether the lithium-ion battery catches fire or explodes. Calculating the 135° C. hot-oven test pass rate as: hot-oven test pass rate=number of batteries passing the 135° C. hot-oven test/5 (total number of batteries tested in 135° C. hot oven).

### Embodiment 1-1

### <Preparing a First Separator>

Using a nonwoven fabric film as a first base film, where the thickness H1 of the nonwoven fabric film is 12 μm, the glass transition temperature Tg1 of the nonwoven fabric film is 90° C., the material of the nonwoven fabric film is polyethylene terephthalate, and the porosity P1 of the first base film is 55% (manufacturer: DuPont, designation: FR543).

Mixing polyvinylidene difluoride (PVDF, with weight-average molecular weight Mw=8.5×10⁶) as a first binder and sodium carboxymethyl cellulose (Mw=8×10⁵) as a thickener at a mass ratio of 98.5:1.5, adding deionized water as a solvent, and stirring well to form a first adhesive layer slurry in which the solid content is 75 wt %.

Mixing aluminum oxide (Al₂O₃) as first ceramic particles, styrene-butadiene rubber (Mw=7×10⁶) as a first ceramic coating binder, and a deionized water solvent at a mass ratio of 35:10:55 to obtain a first ceramic coating slurry.

Applying the first adhesive layer slurry onto one surface of the first base film, and performing oven-drying at 60° C. to form a first adhesive layer on one surface of the first base film; applying the first ceramic coating slurry onto the other surface of the first base film, and performing oven-drying at 60° C. to form a first ceramic coating on the other surface of the first base film; applying the first adhesive layer slurry onto a surface of the first ceramic coating on a side away from the first base film, and performing oven-drying to form another first adhesive layer on the surface of the first ceramic coating on the side away from the first base film, thereby obtaining the first separator. The coating weight CW1 of the first adhesive layer is 0.0008 mg/mm², and the coating weight CW3 of the first ceramic coating is 10 mg/cm².

### <Preparing a Second Separator>

Using a microporous film as a second base film, where the thickness H2 of the film is 7 μm, the glass transition temperature Tg2 of the film is 40° C., the material of the microporous film is polypropylene and polyethylene mixed at a mass ratio of 1:1, and the porosity P2 of the second base film is 18% (manufacturer: Celgard, designation: 2325).

Mixing polyvinylidene difluoride (PVDF, Mw=8.5×10⁶) as a second binder and sodium carboxymethyl cellulose (Mw=8×10⁵) as a second thickener at a mass ratio of 98.5:1.5, adding deionized water as a solvent, stirring the mixture well to form a second adhesive layer slurry in which the solid content is 75 wt %. Mixing aluminum oxide (Al₂O₃) as second ceramic particles, styrene-butadiene rubber (Mw=7×10⁶) as second ceramic coating binder, and a deionized water solvent at a mass ratio of 35:10:55 to obtain a second ceramic coating slurry. Applying the second adhesive layer slurry onto one surface of the second base film, and performing oven-drying at 60° C. to form a second adhesive layer on one surface of the second base film; applying the second ceramic coating slurry onto the other surface of the second base film, and performing oven-drying at 60° C. to form a second ceramic coating on the other surface of the second base film; applying the second adhesive layer slurry onto a surface of the second ceramic coating on a side away from the second base film, and performing oven-drying to form a second adhesive layer on the surface of the second ceramic coating on the side away from the second base film, thereby obtaining the second separator. The coating weight CW2 of the second adhesive layer is 0.0008 mg/mm², and the coating weight CW4 of the second ceramic coating is 10 mg/cm².

### <Preparing a Negative Electrode Plate>

Mixing artificial graphite as a negative active material, styrene-butadiene rubber, and sodium carboxymethyl cellulose at a mass ratio of 97.6:1.1:1.3, adding deionized water as a solvent, and stirring well to obtain a first negative electrode slurry in which the solid content is 70 wt %. At the same time, the first negative electrode slurry also serves as a second negative electrode slurry. Applying the first negative electrode slurry onto one surface of a 6 μm-thick negative current collector copper foil, and oven-drying the slurry at 90° C. to obtain a negative electrode plate coated with a 50 μm-thick first negative electrode material layer. Applying the second negative electrode slurry onto the other surface of the negative current collector copper foil, and oven-drying the slurry to obtain a 106 μm-thick negative electrode plate coated with a 50 μm-thick second negative electrode material layer. Cold-pressing and then cutting the coated negative electrode plate into sheets of 74 mm×824 mm in size for future use. The compaction density of the first negative electrode material layer is 1.735 g/cm³, and the length of the first negative electrode material layer is 720 mm. The compaction density of the second negative electrode material layer is 1.735 g/cm³, and the length of the second negative electrode material layer is 680 mm.

### <Preparing a Positive Electrode Plate>

Mixing lithium cobalt oxide as a positive active material, conductive carbon black as a conductive agent, and polyvinylidene difluoride (PVDF) as a binder at a mass ratio of 95:2.5:2.5, and then adding N-methyl pyrrolidone (NMP) as a solvent, stirring well to obtain a positive electrode slurry in which the solid content is 75 wt %. Applying the positive electrode slurry evenly onto one surface of a 10 μm-thick positive current collector aluminum foil, and oven-drying the slurry at 90° C. to obtain a positive electrode plate coated with a 55 μm-thick positive electrode material layer on a single side. Applying the positive electrode slurry onto the other surface of the positive current collector aluminum foil, and oven-drying the slurry to obtain a 120 μm-thick positive electrode plate coated with a 55 μm-thick positive electrode material layer on both sides. Cold-pressing and then cutting the coated positive electrode plate into sheets of 70 mm×800 mm in size for future use. The compaction density of the positive electrode material layer is 4.23 g/cm³.

### <Preparing an Electrolyte Solution>

Mixing propylene carbonate (PC), diethyl carbonate (DEC), and ethylene carbonate (EC) at a mass ratio of 1:1:1 in a dry argon atmosphere glovebox to form an organic solvent, and then adding hexafluorophosphate (LiPF₆) as a lithium salt into the organic solvent to dissolve, and stirring well to obtain an electrolyte solution. Based on the mass of the electrolyte solution, the mass percent of LiPF₆ is 12%, and the remainder is the organic solvent.

### <Preparing a Lithium-Ion Battery>

Stacking the above-prepared positive electrode plate, first separator, negative electrode plate, and second separator in sequence, and then winding the stacked structure to obtain an electrode assembly. Leading out a positive tab by spot-welding the aluminum foil, and leading out a negative tab by spot-welding the nickel foil. The first ceramic coating in the first separator is close to the positive electrode plate. The second ceramic coating in the second separator faces away from the negative electrode plate. The first negative electrode material layer is close to the first separator, and the second negative electrode material layer is close to the second separator. Putting the electrode assembly into an aluminum laminated film, leaving the electrode assembly in an 80° C. vacuum oven for 12 hours to dehydrate, and then injecting the above-prepared electrolyte solution to form a cell. Performing vacuum sealing, standing, chemical formation (charging the cell at a constant current of 0.02 C until the voltage reaches 3.5 V, and then charging the cell at a constant current of 0.1 C until the voltage reaches 3.9 V), capacity grading, and shaping to obtain a lithium-ion battery.

### Embodiments 1-2 to 1-7

Identical to Embodiment 1-1 except that the relevant preparation parameters are adjusted according to Table 1.

### Embodiment 1-8

Identical to Embodiment 1-1 except that the lithium-ion battery is prepared by the following steps:

### <Preparing a Lithium-Ion Battery>

Stacking the prepared positive electrode plate, first separator, negative electrode plate, and second separator in sequence, and then winding the stacked structure to obtain an electrode assembly. Leading out a positive tab by spot-welding the aluminum foil, and leading out a negative tab by spot-welding the nickel foil. The first ceramic coating in the first separator is close to the positive electrode plate. The second ceramic coating in the second separator faces away from the negative electrode plate. The first negative electrode material layer is close to the second separator, and the second negative electrode material layer is close to the first separator. Putting the electrode assembly into an aluminum laminated film, leaving the electrode assembly in an 80° C. vacuum oven for 12 hours to dehydrate, and then injecting the above-prepared electrolyte solution to form a cell. Performing vacuum sealing, standing, chemical formation (charging the cell at a constant current of 0.02 C until the voltage reaches 3.5 V, and then charging the cell at a constant current of 0.1 C until the voltage reaches 3.9 V), capacity grading, and shaping to obtain a lithium-ion battery.

### Embodiments 2-1 to 2-12

Identical to Embodiment 1-1 except that the relevant preparation parameters are adjusted according to Table 2. When the coating weight CW1 of the first adhesive layer changes, the coating amount of the first adhesive layer slurry is adjusted so that CW1 meets the value specified in Table 2. When the coating weight CW2 of the second adhesive layer changes, the coating amount of the second adhesive layer slurry is adjusted so that CW2 meets the value specified in Table 2. When the coating weight CW3 of the first ceramic coating changes, the coating amount of the first ceramic coating slurry is adjusted so that CW3 meets the value specified in Table 2. When the coating weight CW4 of the second ceramic coating changes, the coating amount of the second ceramic coating slurry is adjusted so that CW4 meets the value specified in Table 2.

### Comparative Embodiment 1

Identical to Embodiment 1-1 except that the method for preparing the first separator is the same as the method for preparing the second separator in Embodiment 1-1.

### Comparative Embodiment 2

Identical to Embodiment 1-1 except that the method for preparing the second separator is the same as the method for preparing the first separator in Embodiment 1-1.

### Comparative Embodiments 3 to 4

Identical to Embodiment 1-1 except that the relevant preparation parameters are adjusted according to Table 1.

Table 1 to Table 2 show the preparation parameters and performance parameters of each embodiment and each comparative embodiment.

TABLE 1

| | | | | | | | | Thickness | 130° C. | 135° C. |
|---|---|---|---|---|---|---|---|---|---|---|
| | Material | Material | | | | | Capacity | of lithium- | hot-oven | hot-oven |
| | of first | of second | H1 | H2 | Tg1 | Tg2 | retention | ion battery | test pass | test pass |
| | base film | base film | (μm) | (μm) | (° C.) | (° C.) | rate (%) | (mm) | rate | rate |
| Embodiment | PET | PP + PE (mass ratio 1:1) | 12 | 7 | 90 | 40 | 90 | 5.1 | 5/5 | 5/5 |
| 1-1 | | | | | | | | | | |
| Embodiment | PET | PP | 12 | 7 | 90 | 50 | 89 | 5.1 | 5/5 | 5/5 |
| 1-2 | | | | | | | | | | |
| Embodiment | PET | PE | 12 | 7 | 90 | 25 | 90 | 5.1 | 5/5 | 5/5 |
| 1-3 | | | | | | | | | | |
| Embodiment | Polyacrylonitrile | PP + PE (mass ratio 1:1) | 12 | 7 | 100 | 40 | 92 | 5.1 | 5/5 | 5/5 |
| 1-4 | | | | | | | | | | |
| Embodiment | Polyphenylene sulfide | PP + PE (mass ratio 1:1) | 12 | 7 | 80 | 40 | 90 | 5.1 | 5/5 | 4/5 |
| 1-5 | | | | | | | | | | |
| Embodiment | PET | PP + PE (mass ratio 1:1) | 10 | 5 | 90 | 40 | 85 | 4.6 | 5/5 | 4/5 |
| 1-6 | | | | | | | | | | |
| Embodiment | PET | PP + PE (mass ratio 1:1) | 15 | 9 | 90 | 40 | 93 | 6.2 | 5/5 | 5/5 |
| 1-7 | | | | | | | | | | |
| Embodiment | PET | PP + PE (mass ratio 1:1) | 12 | 7 | 90 | 40 | 84 | 5.1 | 5/5 | 5/5 |
| 1-8 | | | | | | | | | | |
| Comparative | PP + PE (mass ratio 1:1) | PP + PE (mass ratio 1:1) | 7 | 7 | 40 | 40 | 78 | 4.6 | 3/5 | 0/5 |
| Embodiment 1 | | | | | | | | | | |
| Comparative | PET | PET | 15 | 15 | 90 | 90 | 75 | 6.7 | 5/5 | 5/5 |
| Embodiment 2 | | | | | | | | | | |
| Comparative | PET | PP + PE (mass ratio 1:1) | 7 | 5 | 90 | 40 | 55 | 3.7 | 0/5 | 0/5 |
| Embodiment 3 | | | | | | | | | | |
| Comparative | PET | PP + PE (mass ratio 1:1) | 20 | 15 | 90 | 40 | 72 | 7.3 | 5/5 | 5/5 |
| Embodiment 4 | | | | | | | | | | |

As can be seen from Embodiments 1-1 to 1-8 and Comparative Embodiments 1 to 4, the secondary battery contains a dual-separator structure that includes a nonwoven fabric film and a microporous film, and the thicknesses of the nonwoven fabric film and the microporous film are controlled within the ranges specified herein. This arrangement reduces the thickness of the lithium-ion battery, indicating that the energy density of the lithium-ion battery with the same volume is higher. This arrangement also improves the capacity retention rate and the hot-oven test pass rate at 130° C. and 135° C., indicating that the lithium-ion battery of this application exhibits a longer cycle life and higher safety performance while achieving a desirable energy density. As can be seen from Embodiments 1-1 to 1-8 versus Comparative Embodiment 1, when both the first separator and the second separator are microporous films, the thickness of the lithium-ion battery is relatively small, contributing to a relatively high energy density. However, the capacity retention rate and the 135° C. hot-oven test pass rate of the lithium-ion battery are relatively low, indicating that the resultant lithium-ion battery exhibits a relatively short cycle life and inferior safety performance. As can be seen from Embodiments 1-1 to 1-8 versus Comparative Embodiment 2, when both the first separator and the second separator are nonwoven fabric films, the 130° C. and 135° C. hot-oven test pass rates of the lithium-ion battery are relatively high, but the cycle life is not much improved. In addition, the thickness of the lithium-ion battery is relatively large, contributing to a relatively low energy density. The resultant lithium-ion battery fails to achieve a relatively high energy density although exhibiting good safety performance. This indicates that the lithium-ion battery of this application exhibits a longer cycle life and higher safety performance in addition to a desirable energy density. The thickness of the nonwoven fabric film in Comparative Embodiment 3 is lower than the lower limit of the range specified herein. Although the thickness of the lithium-ion battery is relatively low and contributes to a relatively high energy density, due to the excessively low thickness of the lithium-ion battery, the lithium dendrites generated during the cycling are prone to pierce the relatively weak microporous film to cause a short circuit. Consequently, the capacity retention rate and the 130° C. and 135° C. hot-oven test pass rates are relatively low. The resultant lithium-ion battery exhibits a relatively short cycle life and inferior safety performance. The thicknesses of the nonwoven fabric film and the microporous film in Comparative Embodiment 4 are higher than the upper limit of the range specified herein. Therefore, although the 130° C. and 135° C. hot-oven test pass rates of the lithium-ion battery are relatively high, the thicknesses of the nonwoven fabric film and the microporous film are excessively large, and result in an excessively long transmission path of lithium ions, thereby deteriorating the kinetic performance of the lithium-ion battery and shortening the cycle life. In addition, the thickness of the lithium-ion battery is relatively large and contributes to a relatively low energy density, so that the lithium-ion battery fails to exhibit superior cycle performance and a relatively high energy density despite relatively high safety performance.

The materials of the first base film and/or the second base film typically affect the energy density, cycle life, and safety performance of the lithium-ion battery. As can be seen from Embodiments 1-1 to 1-5, when the materials of the first base film and/or the second base film fall within the ranges specified herein, the thickness of the lithium-ion battery is relatively small, contributing to a relatively high energy density. In addition, the capacity retention rate and the 130° C. and 135° C. hot-oven test pass rates of the lithium-ion battery are relatively high. The lithium-ion battery of this application exhibits a relatively long cycle life and superior safety performance while achieving a desirable energy density.

The structure of the electrode assembly typically affects the energy density, cycle life, and safety performance of the lithium-ion battery. As can be seen from Embodiments 1-1 and 1-8, when the structure of the electrode assembly falls within the range specified herein, the thickness of the lithium-ion battery is relatively small, contributing to a relatively high energy density. In addition, the capacity retention rate and the 130° C. and 135° C. hot-oven test pass rates of the lithium-ion battery are relatively high. The lithium-ion battery of this application exhibits a relatively long cycle life and superior safety performance while achieving a desirable energy density.

The glass transition temperature of the nonwoven fabric film and the glass transition temperature of the microporous film typically affect the energy density, cycle life, and safety performance of the lithium-ion battery. As can be seen from Embodiments 1-1 to 1-5, when the glass transition temperature of the nonwoven fabric film and/or the glass transition temperature of the microporous film falls within the range specified herein, the thickness of the lithium-ion battery is relatively small, contributing to a relatively high energy density. In addition, the capacity retention rate and the 130° C. and 135° C. hot-oven test pass rates of the lithium-ion battery are relatively high. The lithium-ion battery of this application exhibits a relatively long cycle life and superior safety performance while achieving a desirable energy density.

TABLE 2

| | | | | | | | | Thickness | 130° C. | 135° C. |
|---|---|---|---|---|---|---|---|---|---|---|
| | | | | | | | Capacity | of lithium- | hot-oven | hot-oven |
| | CW1 | CW2 | CW3 | CW4 | P1 | P2 | retention | ion battery | test pass | test pass |
| | (mg/mm²) | (mg/mm²) | (mg/cm²) | (mg/cm²) | (%) | (%) | rate (%) | (mm) | rate | rate |
| Embodiment | 0.0008 | 0.0008 | 10 | 10 | 55 | 18 | 90 | 5.1 | 5/5 | 5/5 |
| 1-1 | | | | | | | | | | |
| Embodiment | 0.0004 | 0.0004 | 10 | 10 | 55 | 18 | 92 | 5.1 | 5/5 | 5/5 |
| 2-1 | | | | | | | | | | |
| Embodiment | 0.002 | 0.002 | 10 | 10 | 55 | 18 | 90 | 5.1 | 5/5 | 5/5 |
| 2-2 | | | | | | | | | | |
| Embodiment | 0.0002 | 0.0002 | 10 | 10 | 55 | 18 | 91 | 5.1 | 4/5 | 3/5 |
| 2-3 | | | | | | | | | | |
| Embodiment | 0.003 | 0.003 | 10 | 10 | 55 | 18 | 85 | 5.1 | 5/5 | 5/5 |
| 2-4 | | | | | | | | | | |
| Embodiment | 0.0008 | 0.0008 | 7 | 7 | 55 | 18 | 88 | 4.8 | 5/5 | 5/5 |
| 2-5 | | | | | | | | | | |
| Embodiment | 0.0008 | 0.0008 | 13 | 13 | 55 | 18 | 92 | 5.4 | 5/5 | 5/5 |
| 2-6 | | | | | | | | | | |
| Embodiment | 0.0008 | 0.0008 | 5 | 5 | 55 | 18 | 85 | 4.5 | 4/5 | 1/5 |
| 2-7 | | | | | | | | | | |
| Embodiment | 0.0008 | 0.0008 | 15 | 15 | 55 | 18 | 87 | 5.7 | 5/5 | 5/5 |
| 2-8 | | | | | | | | | | |
| Embodiment | 0.0008 | 0.0008 | 10 | 10 | 40 | 5 | 85 | 5.1 | 5/5 | 5/5 |
| 2-9 | | | | | | | | | | |
| Embodiment | 0.0008 | 0.0008 | 10 | 10 | 70 | 50 | 90 | 5.1 | 5/5 | 4/5 |
| 2-10 | | | | | | | | | | |
| Embodiment | 0.0008 | 0.0008 | 10 | 10 | 30 | 3 | 82 | 5.1 | 5/5 | 5/5 |
| 2-11 | | | | | | | | | | |
| Embodiment | 0.0008 | 0.0008 | 10 | 10 | 80 | 60 | 93 | 5.1 | 4/5 | 0/5 |
| 2-12 | | | | | | | | | | |

The coating weight of the first adhesive layer and/or the coating weight of the second adhesive layer typically affect the energy density, cycle life, and safety performance of the lithium-ion battery. As can be seen from Embodiment 1-1 and Embodiments 2-1 to 2-4, when the coating weight of the first adhesive layer and/or the coating weight of the second adhesive layer fall within the ranges specified herein, the thickness of the lithium-ion battery is relatively small, contributing to a relatively high energy density. In addition, the capacity retention rate and the 130° C. and 135° C. hot-oven test pass rates of the lithium-ion battery are relatively high. The lithium-ion battery of this application exhibits a relatively long cycle life and superior safety performance while achieving a desirable energy density. In Embodiment 2-3, the coating weight of the first adhesive layer and the coating weight of the second adhesive layer in the lithium-ion battery are relatively small, thereby resulting in inferior adhesion between the first separator and the positive electrode plate, between the first separator and the negative electrode plate, between the second separator and the positive electrode plate, and between the second separator and the negative electrode plate. Consequently, the 130° C. and 135° C. hot-oven test pass rates are relatively low, and the safety performance of the lithium-ion battery deteriorates. In Embodiment 2-4, the coating weight of the first adhesive layer and the coating weight of the second adhesive layer in the lithium-ion battery are relatively large. This may cause a relatively large number of pores in the first separator and the second separator to be blocked, and result in a relatively low capacity retention rate and a decline in the cycle performance of the lithium-ion battery.

The coating weight of the first ceramic coating and/or the coating weight of the second ceramic coating typically affect the energy density, cycle life, and safety performance of the lithium-ion battery. As can be seen from Embodiment 1-1 and Embodiments 2-5 to 2-8, when the coating weight of the first ceramic coating and/or the coating weight of the second ceramic coating fall within the ranges specified herein, the thickness of the lithium-ion battery is relatively small, contributing to a relatively high energy density. In addition, the capacity retention rate and the 130° C. and 135° C. hot-oven test pass rates of the lithium-ion battery are relatively high. The lithium-ion battery of this application exhibits a relatively long cycle life and superior safety performance while achieving a desirable energy density. During the hot-oven test, the first separator and the second separator shrink. The coating weight of the first ceramic coating and the coating weight of the second ceramic coating in the lithium-ion battery in Embodiment 2-7 are relatively small, so that the binding ability of the first ceramic coating to the first separator is relatively low and the binding ability of the second ceramic coating to the second separator in the lithium-ion battery is relatively low. Consequently, the 130° C. and 135° C. hot-oven test pass rates of the lithium-ion battery are relatively low, thereby resulting in a decline in the safety performance of the lithium-ion battery. In addition, the coating weight of the first ceramic coating and the coating weight of the second ceramic coating are relatively low, so that the first separator and the second separator can store a relatively small amount of electrolyte solution, and the cycle performance of the lithium-ion battery deteriorates. The coating weight of the first ceramic coating and the coating weight of the second ceramic coating in the lithium-ion battery in Embodiment 2-8 are relatively large, thereby exerting an adverse effect on the deintercalation of lithium ions, and resulting in a decline in the cycle performance of the lithium-ion battery. In addition, the thickness of the lithium-ion battery is relatively large, thereby impairing the energy density of the lithium-ion battery.

The porosity of the first base film and/or the porosity of the second base film typically affect the energy density, cycle life, and safety performance of the lithium-ion battery. As can be seen from Embodiment 1-1 and Embodiments 2-9 to 2-12, when the porosity of the first base film and/or the porosity of the second base film fall within the ranges specified herein, the thickness of the lithium-ion battery is relatively small, contributing to a relatively high energy density. In addition, the capacity retention rate and the 130° C. and 135° C. hot-oven test pass rates of the lithium-ion battery are relatively high. The lithium-ion battery of this application exhibits a relatively long cycle life and superior safety performance while achieving a desirable energy density. In Embodiment 2-12, the porosity of the first base film and the porosity of the second base film in the lithium-ion battery are relatively high, thereby resulting in relatively low strength of the first base film and the second base film. Consequently, the 130° C. and 135° C. hot-oven test pass rates are relatively low, and the safety performance of the lithium-ion battery deteriorates.

It is hereby noted that the relational terms herein such as “first” and “second” are used merely to differentiate one entity or operation from another, but do not involve or imply any actual relationship or sequence between the entities or operations. Moreover, the terms “include”, “comprise”, and any variation thereof are intended to cover a non-exclusive inclusion relationship by which a process, method, or object that includes or comprises a series of elements not only includes such elements, but also includes other elements not expressly specified or also includes inherent elements of the process, method, or object.

Different embodiments of this application are described in a correlative manner. For the same or similar part in one embodiment, reference may be made to another embodiment. Each embodiment focuses on differences from other embodiments.

What is described above is merely exemplary embodiments of this application, but is not intended to limit this application. Any modifications, equivalent replacements, improvements, and the like made without departing from the spirit and principles of this application still fall within the protection scope of this application.

What is claimed is:

1. A secondary battery, comprising an electrode assembly; wherein the electrode assembly comprises a positive electrode plate, a negative electrode plate, a first separator, and a second separator; the first separator is located between the positive electrode plate and the negative electrode plate; the negative electrode plate is located between the first separator and the second separator; the first separator comprises a first base film; the second separator comprises a second base film; the first base film is a nonwoven fabric film; the second base film is a microporous film; a thickness of the nonwoven fabric film is 10 μm to 15 μm; and a thickness of the microporous film is 5 μm to 9 μm.

2. The secondary battery according to claim 1, wherein the electrode assembly has a jelly-roll structure; the negative electrode plate comprises a negative current collector; a first negative electrode material layer and a second negative electrode material layer are located on two sides of the negative current collector respectively; along a winding direction of the electrode assembly, a length of the first negative electrode material layer is greater than a length of the second negative electrode material layer; the first separator is located on a same side as the first negative electrode material layer of the negative electrode plate; and the second separator is located on a same side as the second negative electrode material layer of the negative electrode plate.

3. The secondary battery according to claim 1, wherein the first separator comprises a first adhesive layer located on both sides of the first base film and a first ceramic coating disposed on a surface of the first base film on a side facing towards the positive electrode plate; the first ceramic coating is located between the first base film and the first adhesive layer; the second separator comprises a second adhesive layer located on both sides of the second base film and a second ceramic coating disposed on a surface of the second base film on a side facing away from the negative electrode plate; the second ceramic coating is located between the second base film and the second adhesive layer; and a coating weight of the first adhesive layer is greater than a coating weight of the second adhesive layer.

4. The secondary battery according to claim 3, wherein the coating weight of the first adhesive layer is 0.0004 mg/mm² to 0.002 mg/mm², and the coating weight of the second adhesive layer is 0.0004 mg/mm² to 0.002 mg/mm².

5. The secondary battery according to claim 3, wherein the coating weight of the first ceramic coating is 7 mg/cm² to 13 mg/cm², and the coating weight of the second ceramic coating is 7 mg/cm² to 13 mg/cm².

6. The secondary battery according to claim 3, wherein the first adhesive layer comprises a first binder, the second adhesive layer comprises a second binder; and the first binder and the second binder each are at least one independently selected from polyvinylidene fluoride, polyacrylonitrile, polyethylene oxide, or polyimide.

7. The secondary battery according to claim 1, wherein a porosity of the first base film is 40% to 70%, and a porosity of the second base film is 5% to 50%.

8. The secondary battery according to claim 1, wherein the first base film comprises at least one of polyimide, polyamide, polysulfone, polyacrylonitrile, polyester, cellulose, polyetheretherketone, polyphenylene sulfide, polyacrylate ester, polyethylene terephthalate, poly(p-benzamide), polyarylethersulfoneketone, aramid fiber, or poly(aromatic sulfone) fiber; the second base film comprises polyolefin; and polymerization monomers of the polyolefin comprise at least one of ethylene, propylene, 1-butene, 1-pentene, 1-hexene, 1-octene, 4-methyl-1-pentene, cyclobutene, cyclopentene, or cyclohexene.

9. The secondary battery according to claim 8, wherein the nonwoven fabric film comprises polyethylene terephthalate, and the microporous film comprises at least one of polypropylene or polyethylene.

10. The secondary battery according to claim 1, wherein a glass transition temperature of the nonwoven fabric film is 80° C. to 100° C., and a glass transition temperature of the microporous film is 25° C. to 50° C.

11. An electronic device, comprising the secondary battery according to claim 1.

12. The electronic device according to claim 11, wherein the electrode assembly has a jelly-roll structure; the negative electrode plate comprises a negative current collector; a first negative electrode material layer and a second negative electrode material layer located on two sides of the negative current collector respectively; along a winding direction of the electrode assembly, a length of the first negative electrode material layer is greater than a length of the second negative electrode material layer; the first separator is located on a same side as the first negative electrode material layer of the negative electrode plate; and the second separator is located on a same side as the second negative electrode material layer of the negative electrode plate.

13. The electronic device according to claim 11, wherein the first separator comprises a first adhesive layer located on both sides of the first base film and a first ceramic coating disposed on a surface of the first base film on a side facing towards the positive electrode plate; the first ceramic coating is located between the first base film and the first adhesive layer; the second separator comprises a second adhesive layer located on both sides of the second base film and a second ceramic coating disposed on a surface of the second base film on a side facing away from the negative electrode plate; the second ceramic coating is located between the second base film and the second adhesive layer; and a coating weight of the first adhesive layer is greater than a coating weight of the second adhesive layer.

14. The electronic device according to claim 13, wherein the coating weight of the first adhesive layer is 0.0004 mg/mm² to 0.002 mg/mm², and the coating weight of the second adhesive layer is 0.0004 mg/mm² to 0.002 mg/mm².

15. The electronic device according to claim 13, wherein the coating weight of the first ceramic coating is 7 mg/cm² to 13 mg/cm², and the coating weight of the second ceramic coating is 7 mg/cm² to 13 mg/cm².

16. The electronic device according to claim 13, wherein the first adhesive layer comprises a first binder, the second adhesive layer comprises a second binder, and the first binder and the second binder each are at least one independently selected from polyvinylidene fluoride, polyacrylonitrile, polyethylene oxide, or polyimide.

17. The electronic device according to claim 11, wherein a porosity of the first base film is 40% to 70%, and a porosity of the second base film is 5% to 50%.

18. The electronic device according to claim 11, wherein the first base film comprises at least one of polyimide, polyamide, polysulfone, polyacrylonitrile, polyester, cellulose, polyetheretherketone, polyphenylene sulfide, polyacrylate ester, polyethylene terephthalate, poly(p-benzamide), polyarylethersulfoneketone, aramid fiber, or poly(aromatic sulfone) fiber; the second base film comprises polyolefin; and polymerization monomers of the polyolefin comprise at least one of ethylene, propylene, 1-butene, 1-pentene, 1-hexene, 1-octene, 4-methyl-1-pentene, cyclobutene, cyclopentene, or cyclohexene.

19. The electronic device according to claim 18, wherein the nonwoven fabric film comprises polyethylene terephthalate, and the microporous film comprises at least one of polypropylene or polyethylene.

20. The electronic device according to claim 11, wherein a glass transition temperature of the nonwoven fabric film is 80° C. to 100° C., and a glass transition temperature of the microporous film is 25° C. to 50° C.
